(19) United States
(12) Patent Application Publication
(10) Pub. No.: US 2016/0328067 A1
(43) Pub. Date: Nov. 10, 2016

(54) ELECTRONIC APPARATUS AND METHOD FOR CONTROLLING ELECTRONIC APPARATUS

(71) Applicant: FUJIKURA LTD., Tokyo (JP)

(72) Inventors: Osamu AOKI, Sakura-shi (JP); Makoto TAKAMATSU, Sakura-shi (JP); Toshiaki WATANABE, Sakura-shi (JP); Yasuyuki TACHIKAWA, Sakura-shi (JP)

(73) Assignee: FUJIKURA LTD., Tokyo (JP)

(21) Appl. No.: 15/108,171

(22) PCT Filed: Dec. 25, 2014
(86) PCT No.: PCT/JP2014/084302

§ 371 Date: Jun. 24, 2016

(30) Foreign Application Priority Data
Dec. 27, 2013 (JP) 2013-272972

(51) Int. Cl. G06F 3/041; G06F 3/044

(52) U.S. Cl. CPC G06F 3/0414; G06F 3/0416; G06F 3/044; G06F 3/0412; G06F 2203/04105; G06F 2203/04111; G06F 2203/04103

(57) ABSTRACT

An electronic apparatus 1 includes a touch panel 30, a panel unit 10 which includes at least a cover member 20, at least one pressure-sensitive sensor 50 which detects a pressing force applied through the panel unit 10, a touch panel controller 81 which generates a data group (X, Y, φ) which includes touch coordinate values detected by the touch panel 30 and another value except the touch coordinate values, a sensor controller 91 which generates a pressure value Pₙ from an output value OPₙ of the pressure-sensitive sensor 50, and a computer 100 which includes at least a touch panel driver 103 and to which the touch panel controller 81 and the sensor controller 91 are electrically connected. The computer 100 further includes a touch panel filter driver 105 which rewrites the other value of the data group (X, Y, φ) to the pressure value Pₙ.

### TECHNICAL FIELD

The present invention relates to an electronic apparatus including a touch panel and a pressure-sensitive sensor, and a method for controlling the electronic apparatus.

For designated countries which permit the incorporation by reference, the contents described and/or illustrated in the documents relevant to Japanese Patent Application No. 2013-272972 filed on Dec. 27, 2013 will be incorporated herein by reference as a part of the description and/or drawings of the present application.

### BACKGROUND ART

There is known a touch display device including a touch-sensor module which detects an X-directional position and a Y-directional position, a pressure sensor which detects a Z-directional position expressed by touch pressure (for example, refer to Patent Document 1). The touch display device further includes an integration device which integrates an X-directional position, a Y-directional position, and a Z-directional position.

### PRIOR ART DOCUMENT

### Patent Document

Patent Document 1:JP2013-161131 A

### SUMMARY OF INVENTION

### Problems to be solved by Invention

When the above-mentioned touch display device is connected to a computer with an operating system, it is necessary to newly develop a specialized device driver. For this reason, there is a problem of causing costs of the touch display device to become high due to an increase in development man-hours and lengthening of a development period.

An object of the present invention is to provide an electronic apparatus capable of reducing the costs by efficiently utilizing a conventional device driver and a method for controlling the electronic apparatus.

### Means for Solving Problems

[1] An electronic apparatus according to the present invention is an electronic apparatus comprising: a touch panel; a panel unit which includes at least a cover member; at least one pressure-sensitive sensor which detects a pressing force applied through the panel unit; a touch panel controller which generates a data group which includes touch coordinate values detected by the touch panel and another value except the touch coordinate values; a sensor controller which generates a pressure value from an output value of the pressure-sensitive sensor; and a computer which includes at least a touch panel driver and to which the touch panel controller and the sensor controller are electrically connected. The electronic apparatus further comprises a rewriter which rewrites the other value of the data group to the pressure value.

[2] In the invention, the computer may further include an operating system to which the data group after rewriting of the other value to the pressure value is input.

[3] In the invention, the rewriter may be a filter driver which the computer includes. The filter driver may rewrite the other value of the data group after being output from the touch panel driver, to the pressure value.

[4] In the invention, the touch panel controller or the sensor controller may include the rewriter, and the rewriter may rewrite the other value of the data group before being input to the touch panel driver, to the pressure value.

[5] In the invention, the sensor controller may periodically output the pressure value to the computer.

[6] In the invention, the touch panel controller may send a signal to the sensor controller, and the sensor controller may output the pressure value to the computer on the basis of the signal from the touch panel controller.

[7] In the invention, the touch panel controller may send a signal to the sensor controller along with generation of the data group, and the sensor controller may periodically generate and update the pressure value and may output the pressure value to the computer when the signal is received from the touch panel controller.

[8] A method according to the present invention is a method for controlling an electronic apparatus includes a touch panel, a panel unit which includes at least a cover member, at least one pressure-sensitive sensor which detects a pressing force applied through the panel unit, and a computer which includes at least a touch panel driver and to which the touch panel and the pressure-sensitive sensor are electrically connected. The method comprises: a first step for generating a data group which includes touch coordinate values detected by the touch panel and another value except the touch coordinate values; a second step for generating a pressure value from an output value of the pressure-sensitive sensor; and a third step for rewriting the other value of the data group to the pressure value.

[9] In the invention, the method for controlling the electronic apparatus may comprise a fourth step for inputting the data group after rewriting of the other value to the pressure value, to an operating system which the computer includes.

[10] In the invention, the third step may be performed after the data group is input to the computer.

[11] In the invention, the third step may be performed before the data group is input to the computer.

[12] In the invention, the second step may include periodical outputting the pressure value to the computer.

[13] In the invention, the electronic apparatus may include: a touch panel controller which generates the data group; and a sensor controller which generates the pressure value. The touch panel may be electrically connected to the computer through the touch panel controller, and the pressure-sensitive sensor may be electrically connected to the computer through the sensor controller. The first step may include outputting a signal to the sensor controller by the touch panel controller, and the second step may include outputting the pressure value to the computer by the sensor controller on the basis of the signal from the touch panel controller.

[14] In the invention, the electronic apparatus may comprise a touch panel controller which generates the data group; and a sensor controller which generates the pressure value. The touch panel may be electrically connected to the computer through the touch panel controller, and the pressure-sensitive sensor may be electrically connected to the computer through the sensor controller. The first step may include outputting a signal to the sensor controller by the touch panel controller along with generation of the data group, and the second step may include periodically generating and updating the pressure value by the sensor controller, and outputting the pressure value to the computer by the sensor controller when the signal is received from the touch panel controller.

### Effect of Invention

According to the present invention, the other value except touch coordinate values of a data group including the touch coordinate values detected by the touch panel is rewritten to a pressure value, therefore a touch panel driver of the computer can be used as it is. Accordingly, it is possible to reduce development man-hours, and shorten a development period, thus it is possible to reduce the costs of the electronic apparatus.

### BRIEF DESCRIPTION OF DRAWINGS

FIG. 1 is a plan view of an electronic apparatus in the embodiment of the present invention.

FIG. 2 is a cross-sectional view taken along line II-II in FIG. 1.

FIG. 3 is an exploded perspective view of a touch panel in the embodiment of the present invention.

FIG. 4 is a cross-sectional view of a pressure-sensitive sensor in the embodiment of the present invention.

FIG. 5 is an enlarged cross-sectional view showing a modification example of the pressure-sensitive sensor in the embodiment of the present invention.

FIG. 6 is a plan view of a display device in the embodiment of the present invention.

FIG. 7 is a block diagram showing a system configuration of an electronic apparatus in the embodiment of the present invention.

FIG. 8 is a block diagram showing details of a sensor module in FIG. 7.

FIG. 9 is a circuit diagram showing details of an acquisition part in FIG. 8.

FIG. 10 is a circuit diagram showing a first modification example of the acquisition part in the embodiment of the present invention.

FIG. 11 is a circuit diagram showing a second modification example of the acquisition part in the embodiment in the present invention.

FIG. 12 is a graph showing pressing force-output characteristics of the pressure-sensitive sensor.

FIG. 13 is a block diagram showing a first modification example of the system configuration of the electronic apparatus in the embodiment of the present invention.

FIG. 14 is a block diagram showing a second modification example of the system configuration of the electronic apparatus in the embodiment of the present invention.

FIG. 15 is a sequence diagram showing control contents of the electronic apparatus in the embodiment of the present invention.

FIG. 16 is a flow chart showing details of the process in step S70 in FIG. 15.

### MODES FOR CARRYING OUT THE INVENTION

Hereinafter, an embodiment of the invention will be described with reference to the accompanying drawings.

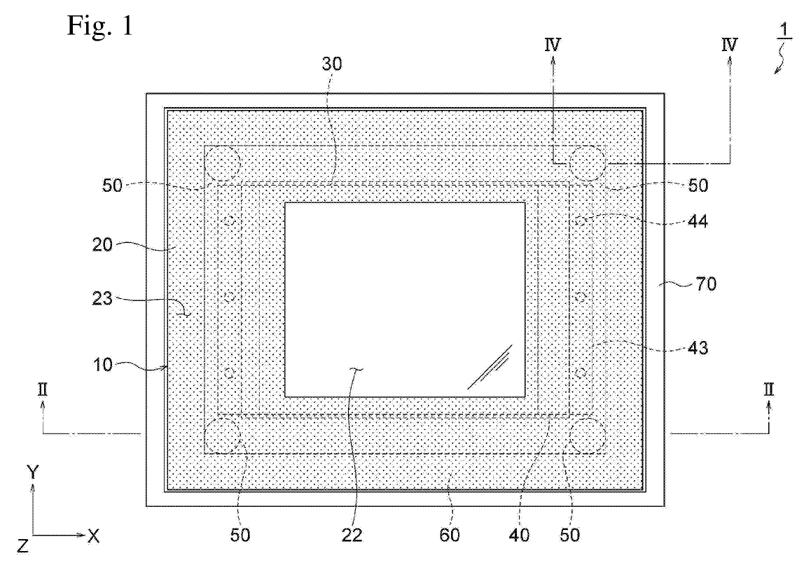

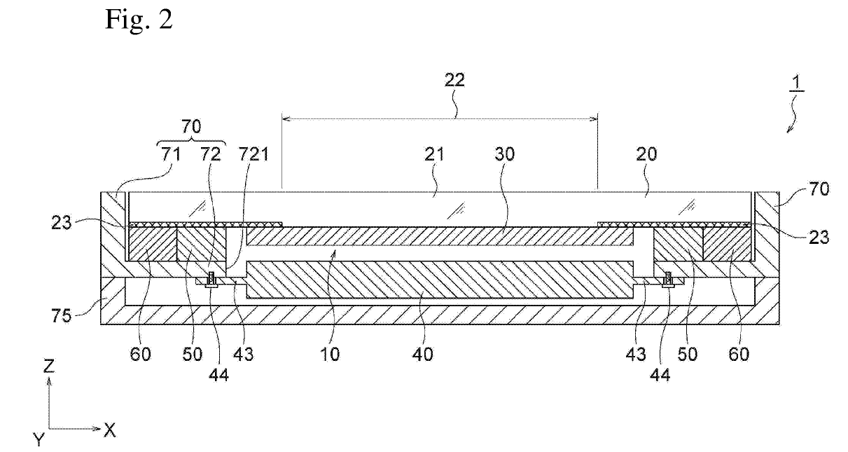

FIG. 1 is a plan view and FIG. 2 is a cross-sectional view of an electronic apparatus in the embodiment of the present invention. The configuration of the electronic apparatus described in the following is only one example and the configuration is not particularly limited thereto.

As illustrated in FIG. 1 and FIG. 2, an electronic apparatus (an electronic device) 1 in the present embodiment includes a panel unit 10, a display device 40, pressure-sensitive sensors 50, a seal member 60, a first support member 70, and a second support member 75. The panel unit 10 includes a cover member 20 and a touch panel 30. The panel unit 10 is supported by the first support member 70 through the pressure-sensitive sensors 50 and the seal member 60, and a minute vertical movement of the panel unit 10 with respect to the first support member 70 is permitted due to the elastic deformations of the pressure-sensitive sensors 50 and the seal member 60.

The electronic apparatus 1 can display an image by the display device 40 (display function). In addition, in a case where an arbitrary position on the display is indicated by a finger of an operator, a touch pen, or the like, the electronic apparatus 1 can detect X and Y coordinates of the position with the touch panel 30 (position input function). Further, in a case where the panel unit 10 is pressed in the Z-direction with a finger of the operator or the like, the electronic apparatus 1 can detect the pressing operation with the pressure-sensitive sensors 50 (pressing detection function).

As illustrated in FIG. 1 and FIG. 2, the cover member 20 is constituted by a transparent substrate 21 through which visible light beams can be transmitted. Specific examples of such material of which the transparent substrate 21 is made include glass, polymethylmethacrylate (PMMA), polycarbonate (PC), and the like.

For example, a shielding portion (bezel portion) 23, which is formed by applying white ink, black ink, or the like, is provided on a lower surface of the transparent substrate 21. The shielding portion 23 is formed in a frame shape in a region on the lower surface of the transparent substrate 21 except for a rectangular transparent portion 22 which is located at the center of the lower surface.

The shapes of the transparent portion 22 and the shielding portion 23 are not particularly limited to the above-described shapes. A decorating member which is decorated with a white color or a black color may be laminated on a lower surface of the transparent substrate 21 so as to form the shielding portion 23. Alternatively, a transparent sheet, which has substantially the same size as the transparent substrate 21 and in which only a portion corresponding to the shielding portion 23 is colored with a white color or a black color, may be prepared, and the sheet may be laminated on the lower surface of the transparent substrate 21 so as to form the shielding portion 23.

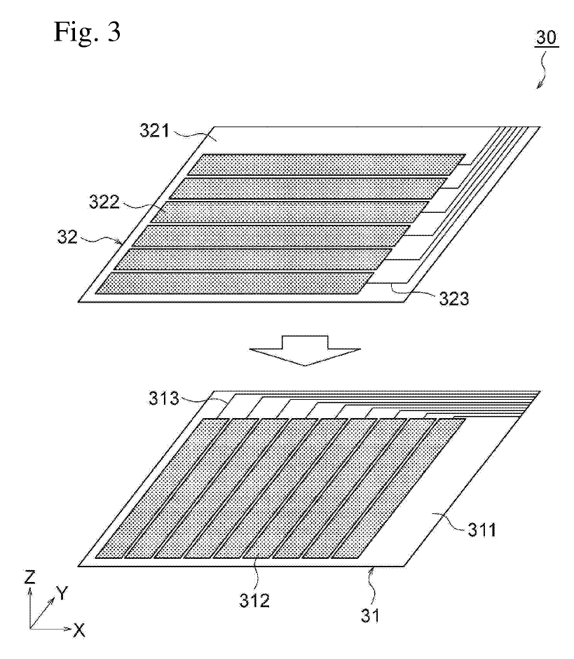

FIG. 3 is an exploded perspective view of a touch panel in the present embodiment.

As illustrated in FIG. 3, the touch panel 30 is an electrostatic capacitance type touch panel including two electrode sheets 31 and 32 which overlap each other.

The structure of the touch panel is not particularly limited thereto, and for example, a resistive-film-type touch panel or an electromagnetic-induction-type touch panel may be employed. Electrode patterns 312 and 322 described below may be formed on the lower surface of the cover member 20, and the cover member 20 may be used as a part of the touch panel. Alternatively, a touch panel prepared by forming an electrode on both surfaces of a sheet may be used instead of the two electrode sheets 31 and 32.

The first electrode sheet 31 includes a first transparent base material (substrate) 311 through which visible light beams can be transmitted, and first electrode patterns 312 which are provided on the first transparent base material 311.

Specific examples of a material of which the first transparent base material 311 is made include resin materials such as polyethylene terephthalate (PET), polyethylene naphthalate (PEN), polyethylene (PE), polypropylene (PP), polystyrene (PS), an ethylene-vinyl acetate copolymer resin (EVA), vinyl resin, polycarbonate (PC), polyamide (PA), polyimide (PI), polyvinyl alcohol (PVA), an acrylic resin, and triacetyl cellulose (TAC) and glass.

For example, the first electrode patterns 312 are transparent electrodes which are made of indium tin oxide (ITO) or a conductive polymer, and are configured as strip-like face patterns (so-called solid patterns) which extend in the Y-direction in FIG. 3. In an example illustrated in FIG. 3, nine first electrode patterns 312 are arranged in parallel on the first transparent base material 311. The shape, the number, the arrangement, and the like of the first electrode patterns 312 are not particularly limited to the above-described configurations.

In the case where the first electrode patterns 312 are made of ITO, for example, the first electrode patterns 312 are formed through sputtering, photolithography, and etching. On the other hand, in the case where the first electrode patterns 312 are made of a conductive polymer, the first electrode patterns 312 can be formed through sputtering and the like similar to the case of ITO, or can be formed through a printing method such as screen printing and gravure-offset printing, or through etching after coating.

Specific examples of the conductive polymer of which the first electrode patterns 312 are made include organic compounds such as a polythiophene-based compound, a polypyrrole-based compound, a polyaniline-based compound, a polyacetylene-based compound, and a polyphenylene-based compound. A PEDOT/PSS compound is preferably used among these compounds.

The first electrode patterns 312 may be formed by printing conductive paste on the first transparent base material 311 and by curing the conductive paste. In this case, each of the first electrode patterns 312 is formed in a mesh shape instead of the face pattern so as to secure sufficient light transmittance of the touch panel 30. As the conductive paste, for example, conductive paste obtained by mixing metal particles such as silver (Ag) and copper (Cu) and a binder such as polyester and polyphenol can be used.

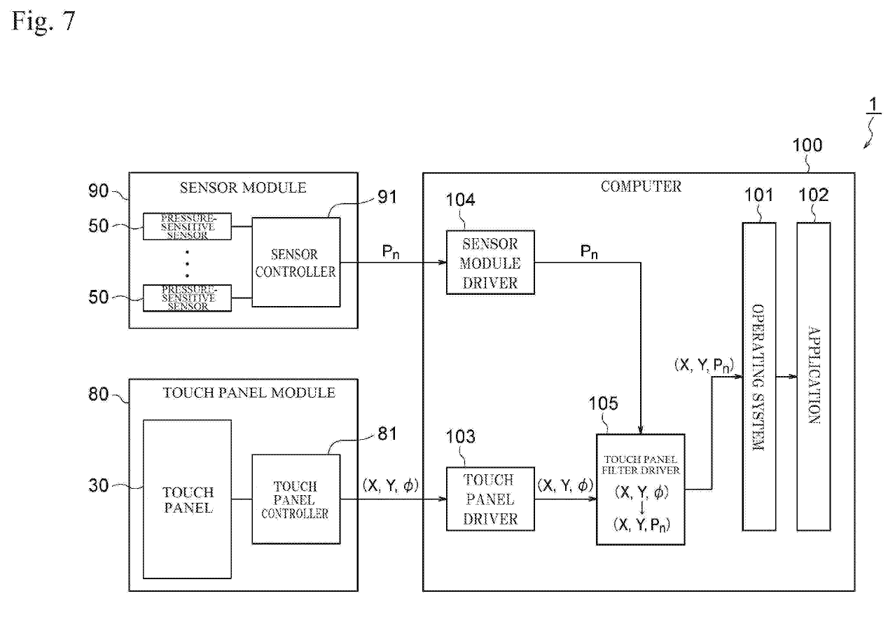

The first electrode patterns 312 are connected to a touch panel controller 81 (refer to FIG. 7) through a first lead-out wiring pattern 313. The first lead-out wiring pattern 313 is provided at a position, which faces the shielding portion 23 of the cover member 20, on the first transparent base material 311, and the first lead-out wiring pattern 313 is not visually recognized by the operator. Therefore, the first lead-out wiring pattern 313 is formed by printing conductive paste on the first transparent base material 311 and by curing the conductive paste.

The second electrode sheet 32 also includes a second transparent base material (substrate) 321 through which visible light beams can be transmitted, and second electrode patterns 322 which are provided on the second transparent base material 321.

The second transparent base material 321 is made of the same material as in the above-described first transparent base material 311. Similar to the above-described first electrode patterns 312, the second electrode patterns 322 are also transparent electrodes which are made of, for example, indium tin oxide (ITO) or a conductive polymer.

The second electrode patterns 322 are configured as strip-like face patterns which extend in the X-direction in FIG. 3. In an example illustrated in FIG. 3, six second electrode patterns 322 are arranged in parallel on the second transparent base material 321. The shape, the number, the arrangement, and the like of the second electrode patterns 322 are not particularly limited to the above-described configurations.

The second electrode patterns 322 are connected to the touch panel controller 81 (refer to FIG. 7) through a second lead-out wiring pattern 323. The second lead-out wiring pattern 323 is provided at a position, which faces the shielding portion 23 of the cover member 20, on the second transparent base material 321, and the second lead-out wiring pattern 323 is not visually recognized by the operator. Therefore, similar to the above-described first lead-out wiring pattern 313, the second lead-out wiring pattern 323 is also formed by printing conductive paste on the second transparent base material 321 and by curing the conductive paste.

The first electrode sheet 31 and the second electrode sheet 32 are attached to each other through a transparent gluing agent in such a manner that the first electrode patterns 312 and the second electrode patterns 322 are substantially orthogonal to each other in a plan view. The touch panel 30 itself is attached to the lower surface of the cover member 20 through the transparent gluing agent in such a manner that the first and second electrode patterns 312 and 322 face the transparent portion 22 of the cover member 20. Specific examples of the transparent gluing agent include an acryl-based gluing agent, and the like.

The panel unit 10 including the above-described cover member 20 and touch panel 30 is supported by the first support member 70 through pressure-sensitive sensors 50 and a seal member 60 as shown in FIG. 2. As shown in FIG. 1, the pressure-sensitive sensors 50 are arranged at the four corners of the panel unit 10. On the other hand, the seal member 60, which has a rectangular annular shape, is disposed outside the pressure-sensitive sensors 50 and arranged over the entire circumference of the panel unit 10 along the outer edge of the panel unit 10. The pressure-sensitive sensors 50 and the seal member 60 are each attached to the lower surface of the cover member 20 through a gluing agent and also to the first support member 70 through the gluing agent. The number and the arrangement of the pressure-sensitive sensors 50 are not particularly limited as long as the pressure-sensitive sensors 50 can stably hold the panel unit 10.

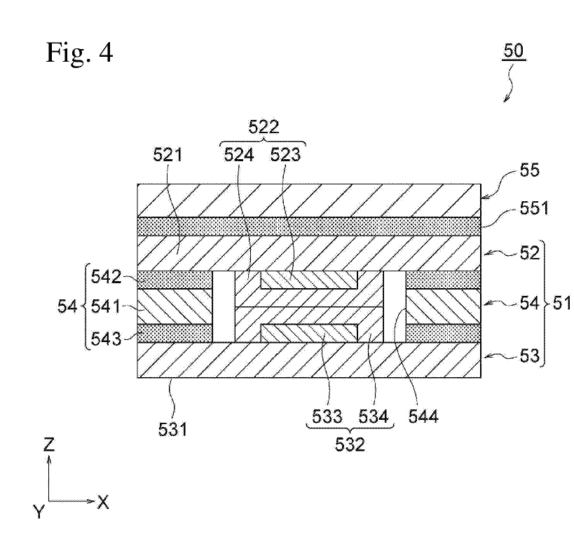

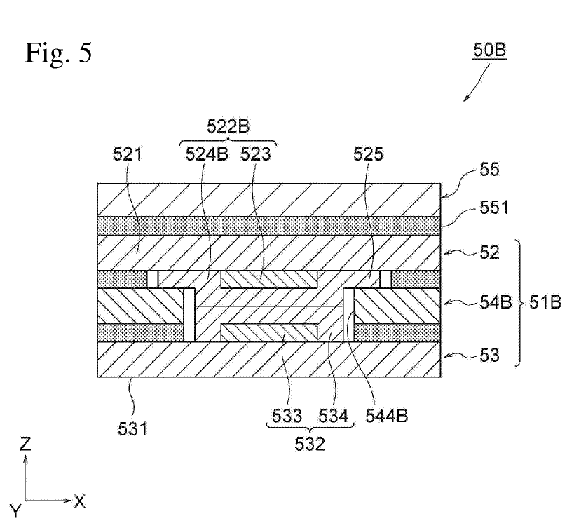

FIG. 4 is a cross-sectional view of a pressure-sensitive sensor in the present embodiment, and FIG. 5 is an enlarged cross-sectional view showing a modification example of the pressure-sensitive sensor in the present embodiment.

As illustrated in FIG. 4, each of the pressure-sensitive sensors 50 includes a detecting part 51 and an elastic member 55. The detecting part 51 includes a first electrode sheet 52, a second electrode sheet 53, and a spacer 54 which is interposed therebetween. FIG. 4 is a cross-sectional view taken along line IV-IV in FIG. 1.

The first electrode sheet 52 includes a first base material (substrate) 521 and an upper electrode 522. The first base material 521 is a flexible insulating film, and is made of, for example, polyethylene terephthalate (PET), polyethylene naphthalate (PEN), polyimide (PI), polyetherimide (PEI), and the like.

The upper electrode 522 includes a first upper electrode layer 523 and a second upper electrode layer 524, and is provided on a lower surface of the first base material 521. The first upper electrode layer 523 is formed by printing conductive paste, which has a relatively low electric resistance, on the lower surface of the first base material 521, and by curing the conductive paste. On the other hand, the second upper electrode layer 524 is formed by printing a conductive paste, which has a relatively high electric resistance, on the lower surface of the first base material 521 so as to cover the first upper electrode layer 523, and by curing the conductive paste.

The second electrode sheet 53 also includes a second base material (substrate) 531 and a lower electrode 532. The second base material 531 is made of the same material as in the above-described first base material 521. The lower electrode 532 includes a first lower electrode layer 533 and a second lower electrode layer 534, and is provided on an upper surface of the second base material 531.

Similar to the above-described first upper electrode layer 523, the first lower electrode layer 533 is formed by printing a conductive paste, which has a relatively low electric resistance, on an upper surface of the second base material 531, and by curing the conductive paste. On the other hand, similar to the above-described second upper electrode layer 524, the second lower electrode layer 534 is formed by printing a conductive paste, which has a relatively high electric resistance, on the upper surface of the second base material 531 so as to cover the first lower electrode layer 533, and by curing the conductive paste.

Examples of a conductive paste, which has a relatively low electric resistance, include silver (Ag) paste, gold (Au) paste, and copper (Cu) paste. In contrast, examples of a conductive paste, which has a relatively high electric resistance, include carbon (C) paste. Examples of a method of printing the conductive paste include screen printing, gravure-offset printing, an inkjet method, and the like.

The first electrode sheet 52 and the second electrode sheet 53 are laminated through the spacer 54. The spacer 54 includes a base material (substrate) 541 and gluing layers 542 and 543 laminated to both sides of the base material 541. The base material 541 is made of an insulating material such as polyethylene terephthalate (PET), polyethylene naphthalate (PEN), polyimide (PI), polyetherimide (PEI), or the like. The base material 541 is attached to the first electrode sheet 52 through the gluing layer 542 and to the second electrode sheet 53 through the gluing layer 543.

A through-hole 544 is formed in the spacer 54 at a position which corresponds to the upper electrode 522 and the lower electrode 532. The upper electrode 522 and the lower electrode 532 are located inside the through-hole 544 and are faced each other. The thickness of the spacer 54 is adjusted so that the upper electrode 522 and the lower electrode 532 come into contact with each other in a state where no pressure is applied to the pressure-sensitive sensors 50.

In a non-load state, the upper electrode 522 and the lower electrode 532 may not come into contact with each other. However, when the upper electrode 522 and the lower electrode 532 are brought into contact with each other in advance in a non-load state, a problem, in which the electrodes do not contact with each other even when a pressure is applied (that is, an output of the pressure-sensitive sensor 50 is zero (0)), does not occur, and detection accuracy of the pressure-sensitive sensor can be improved.

In a state in which a predetermined voltage is applied between the upper electrode 522 and the lower electrode 532 and when a load from the upper side to the pressure-sensitive sensor 50 increases, a degree of adhesion between the upper electrode 522 and the lower electrode 532 increases in accordance with the magnitude of the load, and electric resistance between the electrodes 522 and 532 decreases. On the other hand, when the load to the pressure-sensitive sensor 50 is released, a degree of adhesion between the upper electrode 522 and the lower electrode 532 lowers and electric resistance between the electrodes 522 and 532 increases.

Accordingly, the pressure-sensitive sensor 50 is capable of detecting the magnitude of the pressure applied to the pressure-sensitive sensor 50 on the basis of the resistivity change. The electronic apparatus 1 in the present embodiment detects a pressing operation by an operator to the panel unit 10 by comparing an electric resistance value of the pressure-sensitive sensor 50 with a predetermined threshold value. In the present embodiment, “an increase in the degree of adhesion” means an increase in a microscopic contact area, and “a decrease in the degree of adhesion” means a decrease in the microscopic contact area.

The second upper electrode layer 524 or the second lower electrode layer 534 may be formed by printing a pressure-sensitive ink instead of the carbon paste, and by curing the pressure-sensitive ink. For example, a specific example of the pressure-sensitive ink includes a quantum tunnel composite material which utilizes the quantum tunnel effect. Another example of the pressure-sensitive ink includes, for example, a pressure-sensitive ink containing conductive particles of metal, carbon or the like, elastic particles of an organic elastic filler, inorganic oxide filler or the like, and a binder. The surface of the pressure-sensitive ink is uneven with elastic particles. The electrode layers 523, 524, 533, and 534 can be formed through a plating process or a patterning process instead of the printing method.

In a plan view, when a distance from the center of the panel unit to each of the pressure-sensitive sensors varies, sensitivity of the sensitive sensor closer to the center of the panel unit may be lowered. Specifically, a combined resistance value of the second circuit described later may be decreased or the pressure-sensitive sensor may be made not to bend easily so as to lower sensitivity of the pressure-sensitive sensor.

An elastic member 55 is laid on the first electrode sheet 52 through a gluing agent 551. The elastic member 55 is made from an elastic material such as a foaming material or rubber material. Specific examples of the foaming material constituting the elastic member 55 include, for example, a urethane foam, a polyethylene foam, and a silicone foam each of which has closed cells. Further, examples of the rubber material constituting the elastic member 55 include a polyurethane rubber, a polystyrene rubber, and a silicone rubber. The elastic member 55 may be laid under the second electrode sheet 53. Alternatively, the elastic members 55 may be laid on the first electrode sheet 52 and also under the second electrode sheet 53.

By providing the elastic member 55 to the pressure-sensitive sensor 50, the load applied to the pressure-sensitive sensor 50 can be dispersed evenly throughout the detecting part 51 and detection accuracy of the pressure-sensitive sensor 50 can be improved. When the support member 70, 75, or the like is distorted or when the tolerance of the support member 70, 75, or the like in the thickness direction is large, the distortion and tolerance can be absorbed by the elastic member 55. When excess pressure or shock is applied to the pressure-sensitive sensor 50, damage or destruction of the pressure-sensitive sensor 50 can also be prevented with the elastic member 55.

The structure of the pressure-sensitive sensor is not particularly limited to the above. For example, as in the pressure-sensitive sensor 50B shown in FIG. 5, by forming an annular protruding part 525 by a second upper electrode layer 524B of an upper electrode 522B, a spacer 54B may be sandwiched between the protruding part 525 and the second base material 531. The protruding part 525 protrudes radially from the upper part of the upper electrode 522B. Further, as for the spacer 54B in the present example, a diameter of an upper part opening of the through-hole 544B is expanded, and the protruding part 525 of the upper electrode 522B can be housed therein.

Instead of the pressure-sensitive sensor having the structure explained above, for example, an electrostatic capacitance type sensor, a pressure-sensitive conductive rubber, a piezoelectric element, a strain gauge, or the like may be used as the pressure-sensitive sensor. Alternatively, a Micro Electro Mechanical Systems (MEMS) element of a cantilevered shape (or a both-ends supported shape) having a piezo-resistance layer may be used as the pressure-sensitive sensor. Alternatively, a pressure sensor having a structure of sandwiching polyamino acid material having piezoelectricity between insulating substrates each having formed with an electrode by screen printing may be used as the pressure-sensitive sensor. Alternatively, a piezoelectric element utilizing polyvinylidene fluoride (PVDF) having piezoelectricity may also be used as a pressure-sensitive sensor.

As with the elastic member 55, a seal member 60 is also made of an elastic material such as a foaming material, rubber material or the like. Specific examples of the foaming material forming the seal member include, for example, a urethane foam, a polyethylene foam, a silicone foam, or the like each of which has closed cells. Further, examples of the rubber material forming the seal member 60 include a polyurethane rubber, a polystyrene rubber, a silicone rubber, and the like. By placing such seal member 60 between a cover member 20 and the first support member 70, inclusion of foreign substances from the outside can be prevented.

Preferably, the elasticity modulus of the elastic member 55 is respectively higher than the elasticity modulus of the seal member 60. In this way, pressing force can be accurately transmitted to the pressure-sensitive sensor 50 and detection accuracy of the pressure-sensitive sensor 50 can be improved.

As shown in FIG. 2, the pressure-sensitive sensors 50 and the seal member 60 described above are sandwiched between the cover member 20 and the first support member 70. The first support member 70 includes a frame part 71 and a holder 72. The frame part 71 has a rectangular frame shape with an opening capable of housing the cover member 20. On the other hand, the holder 72 has a rectangular annular shape and is radially protruded to the inside from the lower end of the frame part 71. The pressure sensitive sensors 50 and the seal member 60 are supported by the support member 72 so as to be interposed between the cover member 20 and the first support member 70. The first support member 70 is made of, for example, a metal material such as aluminum and the like, a resin material such as polycarbonate (PC), ABS resin, or the like. The frame part 71 and the holder 72 are integrally formed.

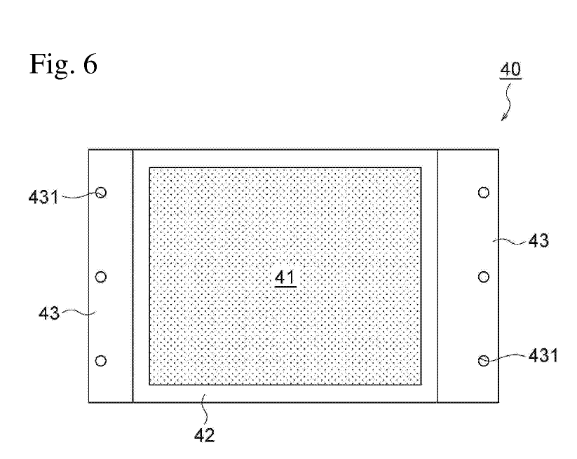

FIG. 6 is a plan view of a display device in the present embodiment.

As illustrated in FIG. 6, the display device 40 includes a display region 41 on which an image is displayed, an outer edge region 42 which surrounds the display region 41, and a flange 43 which protrudes from both ends of the outer edge region 42. For example, the display region 41 of the display device 40 is constituted by a thin-type display device such as a liquid crystal display, an organic EL display, or an electronic paper.

A through-hole 431 is formed to the flange 43. The through-hole 431 faces a screw hole formed on the rear surface of the first support member 70. As shown in FIG. 2, when a screw 44 is screwed into the screw hole of the first support member 70 through the through-hole 431, the display device 40 is fixed to the first support member 70. Accordingly, the display region 41 faces a transparent portion 22 of the cover member 20 through a center opening 721 of the first support member 70.

Like the first support member 70 described above, the second support member 75 is made of, for example, a metal material such as aluminum or the like, or a resin material such as polycarbonate (PC), ABS resin, or the like. The second support member 75 is attached to the first support member 70 through a gluing agent so as to cover the rear surface of the display device 40. Instead of the gluing agent, the second support member 75 may be fastened with a screw to the first support member 70.

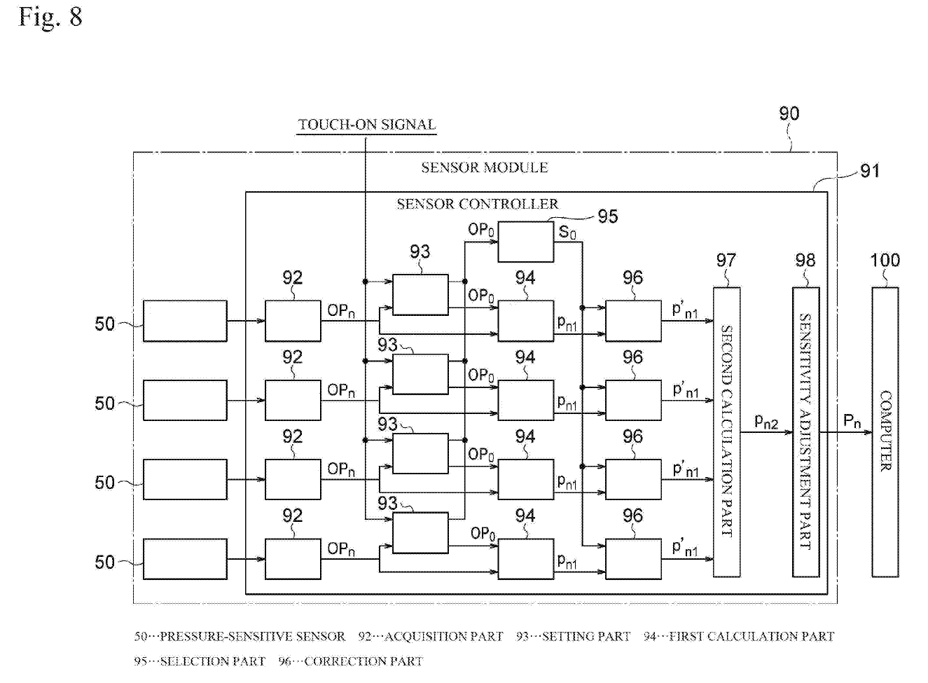

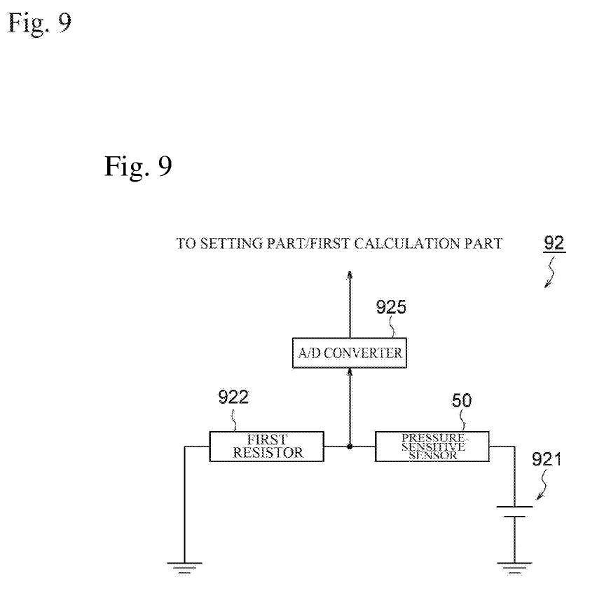

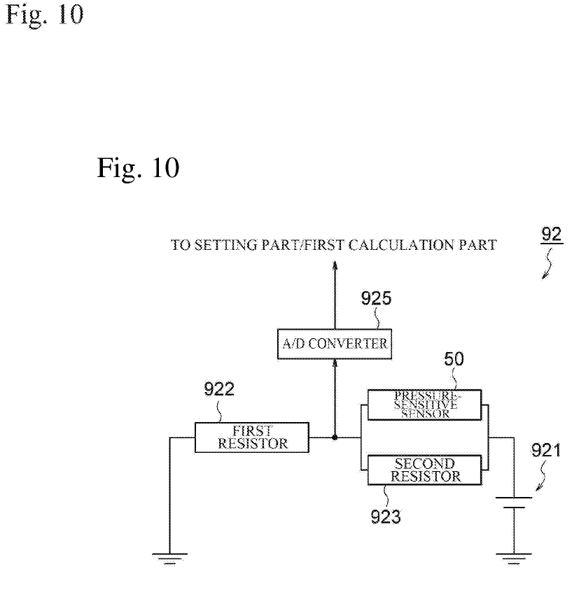

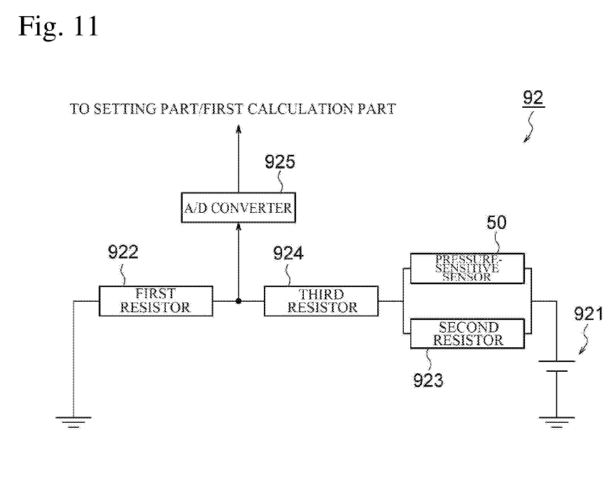

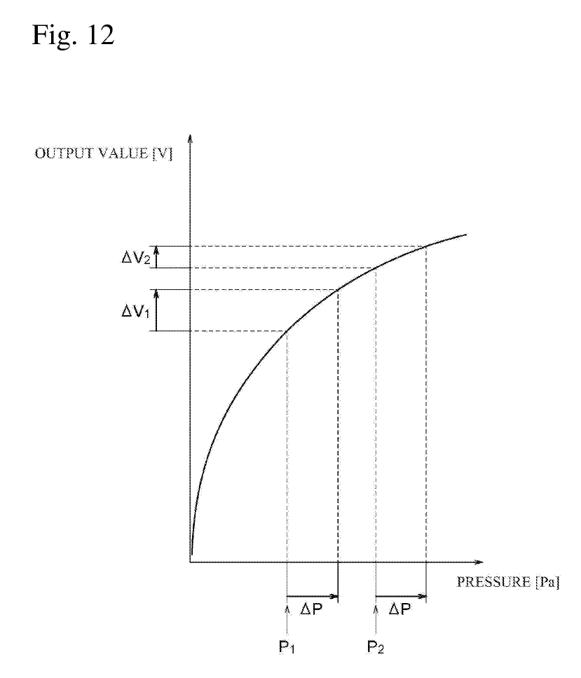

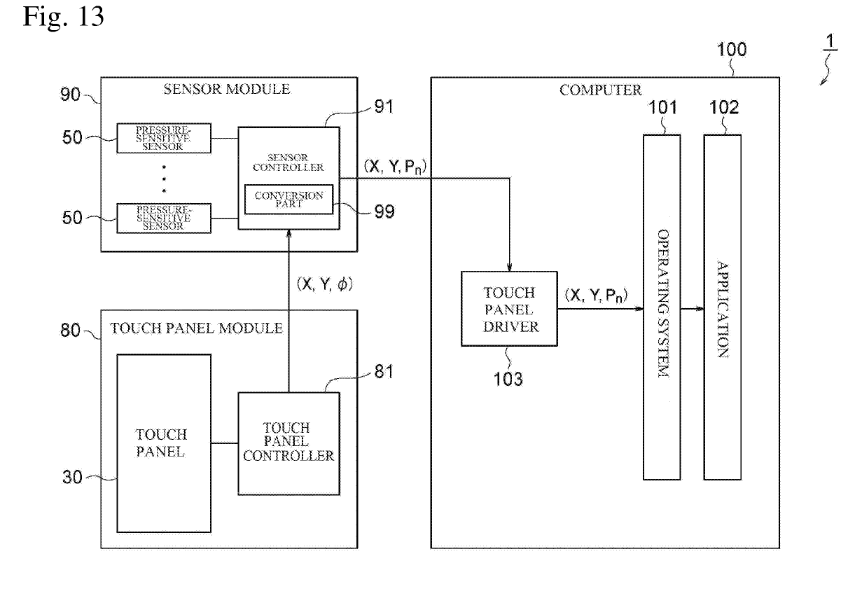

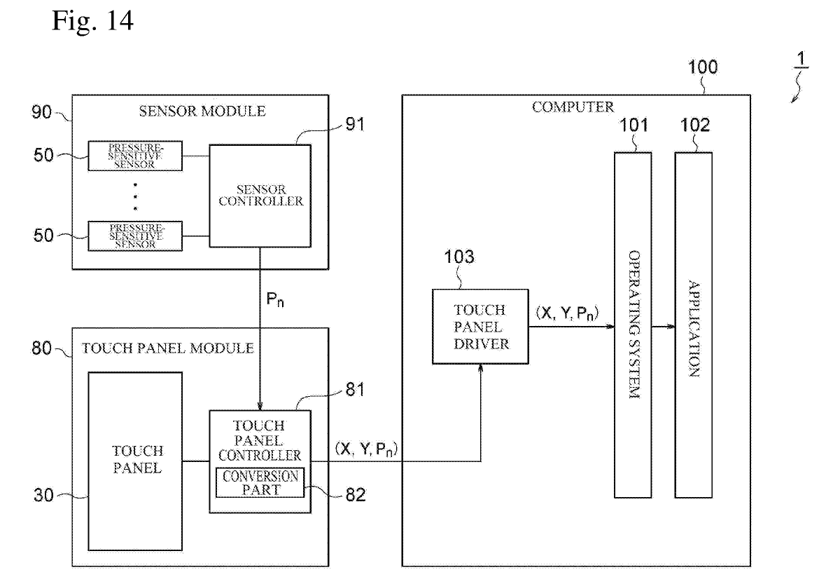

FIG. 7 is a block diagram showing a system configuration of the electronic apparatus in the present embodiment. FIG. 8 is a block diagram showing details of the sensor module in FIG. 7. FIG. 9 is a circuit diagram showing details of an acquisition part in FIG. 8. FIG. 10 and FIG. 11 are the circuit diagrams showing modification examples of the acquisition part. FIG. 12 is a graph showing pressing force-output characteristics of the pressure-sensitive sensor. FIG. 13 and FIG. 14 are the block diagrams showing modification examples of the system configuration of the electronic apparatus in the present embodiment.

As shown in FIG. 7, an electronic apparatus 1 in the present embodiment includes a touch panel module 80, a sensor module 90, and a computer 100 to which the modules 80 and 90 are electrically connected.

The touch panel module 80 includes the touch panel 30 and a touch panel controller 81 electrically connected to the touch panel 30.

The touch panel controller 81 includes, for example, an electrical circuit or the like including such as a CPU. The touch panel controller 81 periodically applies a predetermined voltage between the first electrode patterns 312 and second electrode patterns 322 of the touch panel 30, detects a position (an X-coordinate value and a Y-coordinate value) of a finger on the touch panel 30 on the basis of a variation in electrostatic capacitance at each intersection between the first electrode patterns 312 and the second electrode patterns 322, and outputs the X and Y coordinate values to the computer 100.

When a value of the electrostatic capacitance becomes a predetermined threshold value or more, the touch panel controller 81 detects that a finger of the operator came into contact with the cover member 20 and notices a touch-on to the computer 100. When a value of the electrostatic capacitance becomes less than a predetermined threshold value, the touch panel controller 81 detects that a finger of the operator became untouched from the cover member 20 and notices a touch-off to the computer 100. When the touch panel controller 81 detects that the finger of the operator approaches the cover member 20 within a predetermined distance (a so-called hover state), the touch panel controller 81 may notice a touch-on.

The sensor module 90 includes the pressure-sensitive sensors 50 and a sensor controller 91 electrically connected to the pressure-sensitive sensors 50.

Like the touch panel controller 81, the sensor controller 91 includes, for example, an electrical circuit with a CPU or the like. The sensor controller 91 functionally includes, as shown in FIG. 8, acquisition parts 92, setting parts 93, first calculation parts 94, a selection part 95, correction parts 96, a second calculation part 97, and a sensitivity adjustment part 98.

As illustrated in FIG. 9, the acquisition part 92 includes a power supply 921 which is connected in series to the upper electrode 522 (or the lower electrode 532) of the pressure-sensitive sensor 50, a first resistor 922 which is connected in series to the lower electrode 532 (or the upper electrode 522) of the pressure-sensitive sensor 50, and an A/D converter 925 which is connected between the pressure-sensitive sensor 50 and a first fixed resistor 922. The A/D converter 925 in the present embodiment corresponds to an example of an A/D conversion part of the present invention.

In a state in which a predetermined voltage is applied between the electrodes 522 and 532 by the power supply 921, when a load from an upper side to the pressure-sensitive sensor 50 increases, an electrical resistance value between the electrodes 522 and 532 varies in accordance with the magnitude of the load. The acquisition part 92 periodically samples an analog signal of a voltage value, which corresponds to the resistance variation, from the pressure-sensitive sensor 50 at a constant interval, converts the analog signal into a digital signal with an A/D converter 925, and outputs the digital signal to the setting part 93 and the first calculation part 94.

As shown in FIG. 9, in a case where the acquisition part 92 includes a first circuit including a pressure-sensitive sensor 50 and a second circuit including a first fixed resistor 922 and electrically connected in series to the first circuit, a combined resistance value of the second circuit is preferably 1/16 to 1/1 times a combined resistance value of the first circuit when ½ of the maximum working load of the pressure-sensitive sensor 50 is applied. In this way, output characteristics of the pressure-sensitive sensor 50 can be brought to a straight line, thus detection accuracy of the pressure-sensitive sensor 50 can be improved.

Here, the maximum working load of the pressure-sensitive sensor 50 means a maximum value within a designed usable load range set to the pressure-sensitive sensor 50 installed in an electronic apparatus 1, which is, for example, 8 [N]. The maximum working load of the pressure-sensitive sensor 50 may be set to the load at the point when a resistance value of the pressure-sensitive sensor 50 decreases by 50 [Ω] while the load applied to the pressure-sensitive sensor 50 increases by 1 [N].

As illustrated in FIG. 10, the acquisition part 92 may include a second fixed resistor 923 which is connected in parallel to the pressure-sensitive sensor 50. In this case, a parallel circuit of the pressure-sensitive sensor 50 and the second fixed resistor 923 corresponds to the first circuit, and the first fixed resistor 922 corresponds to the second circuit.

As illustrated in FIG. 11, the acquisition part 92 may include a third fixed resistor 924 which is connected in series to a parallel circuit which includes the pressure-sensitive sensor 50 and the second fixed resistor 923. In this case, a parallel circuit constituted by the pressure-sensitive sensor 50 and the second fixed resistor 923 and the third fixed resistor 924 connected in series to the parallel circuit correspond to the first circuit, and the first fixed resistor 922 corresponds to the second circuit.

The sensor controller 91 may include correction means which corrects an output value OPₙ of the acquisition part 92 using a correction function g(Vₒᵤₜ). When the acquisition part 92 includes a circuit shown in FIG. 9, the correction function g(Vₒᵤₜ) is expressed by the following expression (1).

$$\begin{matrix}[ Expression 1 ] & \\ g ( {V}_{out} ) = {V}_{out}^{′} = {\{ \frac{{R}_{fix}}{k} ( \frac{{V}_{in}}{{V}_{out}} - 1 ) \}}^{- \frac{1}{n}} & ( 1 )\end{matrix}$$

In the expression (1), R_{fix} is a resistance value of the first fixed resistor 922, Vᵢₙ is an input-voltage value to the pressure-sensitive sensor 50 (that is, an applied voltage by the power supply 921), Vₒᵤₜ is an output value obtained by the acquisition part 92, Vₒᵤₜ′ is an output value after correction, “k” is an intercept constant of the pressure-sensitive sensor 50, and “n” is an inclination constant of the pressure-sensitive sensor 50.

The values of “k” and “n” are calculated by measuring a resistance value of the pressure-sensitive sensor 50 at a plurality of load points and performing curve-fitting to the following expression (2) using the measured values.

[Expression 2]

Rₛₑₙₛ=k×F⁻ⁿ (2)

The expression (2) is an empirical expression representing characteristics of the pressure-sensitive sensor by utilizing pressure dependency of contact resistance.

In the expression (2), Rₛₑₙₛ is a resistance value of the pressure sensitive sensor 50, and “F” is a load applied to the pressure-sensitive sensor 50.

The correction function g(Vₒᵤₜ) is a function obtained by replacing an output variable Vₒᵤₜ of the pressure-sensitive sensor 50 with a corrected output variable Vₒᵤₜ′ of the pressure-sensitive sensor 50 and also replacing the applied-load variable F to the pressure-sensitive sensor 50 with an output variable Vₒᵤₜ in an inverse function f⁻¹(F) of an output characteristic function f(F) of the pressure-sensitive sensor 50. In other words, the correction function g(Vₒᵤₜ) in the expression (1) is an expression obtained by solving the following expression (3) for the applied-load variable “F” by deformation of the expression (3).

Here, the output characteristic function f(F) of the pressure-sensitive sensor 50 is a function which represents the relationship between the applied-load variable F and the output variable Vₒᵤₜ of the pressure-sensitive sensor 50 and can be represented by the following expression (3). On the other hand, the inverse function f⁻¹(F) is an inverse function of the output characteristic function f(F) for the applied-load variable F and the output variable Vₒᵤₜ, and can be represented by the following expression (4).

$$\begin{matrix}[ Expression 3 ] & \\ f ( f ) = {V}_{out} = {V}_{in} \frac{{R}_{fix}}{{R}_{fix} + k \times {F}^{- n}} & ( 3 ) \\ [ Expression 4 ] & \\ {f}^{- 1} ( F ) = {V}_{out} = {\{ \frac{{R}_{fix}}{k} ( \frac{{V}_{in}}{F} - 1 ) \}}^{- \frac{1}{n}} & ( 4 )\end{matrix}$$

When a touch-on signal is input from a sensor module driver 104 (described later) of the computer 100, a setting part 93 sets, as a reference value OP₀, an output value OPₙ of the pressure-sensitive sensor 50 at the time of or immediately before the detection of the contacting (that is, an output value OPₙ sampled at the same time of or immediately before the detection of the contacting). The setting part 93 is provided for each pressure-sensitive sensor 50 and sets the reference value OP₀ for each pressure-sensitive sensor 50.

The reference value OP₀ also includes 0 (zero). When the touch-on signal indicates that approaching of the finger to the cover member 20 within a predetermined distance is detected, the setting part 93 sets, as the reference value OP₀, an output value OPₙ of the pressure-sensitive sensor 50 at the time of or immediately after the detection of the approaching (that is, an output value OPₙ sampled at the time of or immediately after the detection of the approaching).

The first calculation part 94 calculates a first pressure value Rₙ₁, which is applied to the pressure-sensitive sensor 50, in accordance with the following expression (5). As is the case with the setting part 93, the first calculation part 94 is also provided to each pressure-sensitive sensor 50, and calculates the first pressure value pₙ₁ for each pressure-sensitive sensor 50.

[Expression 5]

pₙ₁=OPₙ−OP₀ (5)

The selection part 95 selects the minimum value among four reference values OP₀ which are set by the four setting parts 93, and sets, as a comparison value S₀, the minimum reference value.

The correction part 96 calculates a correction value Rₙ of each pressure-sensitive sensor 50 in accordance with the following expressions (6) and (7), and corrects the first pressure value pₙ₁ of the pressure-sensitive sensor 50 by using the correction value Rₙ . As is the case with the setting part 93 or the first calculation part 94, the correction part 96 is also provided for each pressure-sensitive sensor 50, and corrects the first pressure value pₙ₁ for each pressure-sensitive sensor 50. The value p′ₙ₁ in the following expression (7) represents a first pressure value after correction.

$$\begin{matrix}[ Expression 6 ] & \\ {R}_{n} = \frac{{OP}_{0}}{{S}_{0}} & ( 6 ) \\ [ Expression 7 ] & \\ {p}_{n 1}^{′} = {p}_{n 1} \times {R}_{n} & ( 7 )\end{matrix}$$

Here, as illustrated in FIG. 12, the pressure-sensitive sensor 50 has the following characteristics. That is, the further a pressure value increases, the smaller an increase rate of an output value becomes. Accordingly, even in the same pressure variation amount ΔP, the larger an initial pressure (pressing initiation pressure or initial load) is, the further a variation amount of the output value tends to decrease, and thus a difference in the variation amount of the output value occurs depending on the initial pressure.

Specifically, as illustrated in the same drawing, when pressing is initiated from a first initial pressure P₁ which is small, the output value of the pressure-sensitive sensor 50 varies by a first variation amount ΔV₁. In contrast, when pressing is initiated from a second initial pressure P₂ greater than the first initial pressure P₁ (P₂>P₁), a variation occurs by only a second variation amount ΔV₂, and the second variation amount ΔV₂ is narrower than the first variation amount ΔV₁. (ΔV₂<ΔV₁).

A different initial pressure may be applied to the four pressure-sensitive sensors 50 provided to the electronic apparatus 1 due to the posture of the electronic apparatus 1, and the like. According to the above-described reason, the first pressure value pₙ₁ , which is calculated by the first calculation part 94, greatly depends on the initial pressure of each pressure-sensitive sensor 50.

In contrast, in the present embodiment, since the first pressure value pₙ₁ is corrected by using the correction value Rₙ to reduce an effect of the initial pressure with respect to the first pressure value pₙ₁ , it is further possible to improve detection accuracy of the pressure-sensitive sensor 50.

As long as the selection part 95 selects any one value among reference values OP₀ as a comparison value S₀, the selection part 95 may select, for example, a maximum value among the reference values OP₀ as the comparison value S₀.

A method of correcting the first pressure value pₙ₁ by the selection part 95 is not particularly limited to the above-described method as long as the further the reference value OP₀ is greater than the comparison value S₀, the larger the first pressure value pₙ₁ is corrected, and the further the reference value OP₀ is smaller than the comparison value S₀, the smaller the first pressure value pₙ₁ is corrected.

The second calculation part 97 calculates, as a second pressure value pₙ₂ which is applied to the cover member 20, the sum of first pressure values after correction p′ₙ₁ of the four pressure-sensitive sensors 50 in accordance with the following expression (8).

[Expression 8]

pₙ₂=Σpₙ₁′ (8)

The sensitivity adjustment part 98 performs sensitivity adjustment for the second pressure value pₙ₂ in accordance with the following expression (9) to calculate a final pressure value Pₙ. The pressure value Pₙ calculated with the expression (9) is output to the computer 100. In the following expression (9), k_{adj} represents a coefficient for adjustment of an individual pressure difference of the operator, which is stored in advance, for example, in a storage part (not illustrated in the drawing) of the touch panel controller 81, and can be accordingly set depending on the operator.

$$\begin{matrix}[ Expression 9 ] & \\ {P}_{n} = \frac{{p}_{n 2}}{{k}_{adj}} & ( 9 )\end{matrix}$$

Although not illustrated in drawings, a selector may be interposed between the four pressure-sensitive sensors 50 and a sensor controller 91. In this case, the sensor controller 91 is only required to include each one of an acquisition part 92, a setting part 93, a first calculation part 94, and a correction part 96.

The computer 100 is an electronic calculator including, although not particularly illustrated in drawings, a CPU, a main memory device (RAM or the like), an auxiliary storage device (a hard disk or an SSD, etc.), and an interface, etc. As shown in FIG. 7, the touch panel controller 81 and the sensor controller 91 are electrically connected to the computer 100 through an interface. The computer 100 reads various programs stored in an auxiliary storage device to enable execution of an operating system 101, an application 102, a touch panel driver 103, a sensor module driver 104, and a touch panel filter driver 105. The touch panel filter driver 105 of the present embodiment corresponds to an example of the rewriter of the present invention.

The operating system (OS) 101 is a basic program for controlling and operating the computer 100. The application 102 is a program which operates in the computer 100 and performs a specific function by utilizing a function provided by the operating system 101.

The touch panel driver 103 is a program to directly control the touch panel module 80. The touch panel driver 103, after receiving a data group from the touch panel module 80, outputs the data group to the touch panel filter driver 105.

The format of a data group to be input to the touch panel driver 103 is predetermined. For example, a format shown in the following expression (10) is set.

[Expression 10]

(X,Y,φ) (10)

In the above input format, “X” is an X-coordinate value of a touched position on the touch panel 30, “Y” is a Y-coordinate value of the touched position on the touch panel 30, and the X-coordinate value and the Y-coordinate value of the touched position in the present embodiment correspond to an example of the touch coordinate values of the present invention. Also, “φ” is, for example, another value other than (except) the X and Y coordinate values of a touched position, such as a touch width, a touch height, a reserved region or the like, or a null value. The number and order of data constituting the input format which the touch panel driver 103 requires are not particularly limited to the above.

The sensor module driver 104 is a program to directly control a sensor module 90. The sensor module driver 104 receives the pressure value Pₙ from the sensor module 90 and outputs the pressure value Pₙ to a touch panel filter driver 105.

The touch panel filter driver 105 rewrites a part of the data group output from the touch panel driver 103, to a pressure value Pₙ output from the sensor module driver 104. Specifically, in the above example, “φ” of a data group (X, Y, φ) is rewritten to a pressure value Pₙ. The touch panel filter driver 105 outputs the rewritten data group (X, Y, Pₙ) to an application 102 through the operating system 101.

For example, when the data group (X, Y, φ) is (809, 205, 0) and the pressure value Pₙ is 120, the touch panel filter driver 105 rewrites the data group to (809, 205, 120). In the present embodiment, “rewriting of a part of a data group” also includes rewriting of a null value of the data group to a pressure value Pₙ, in other words, writing (overwriting) of the pressure value Pₙ to the null value.

Further, as shown in FIG. 13, instead of the touch panel filter driver 105, a sensor controller 91 may include a conversion part 99 in addition to the acquisition part 92, the setting part 93, the first calculation part 94, the selection part 95, the correction part 96, the second calculation part 97, and the sensitivity adjustment part 98 mentioned above.

In this case, the data group (X, Y, φ) is output to the sensor controller 91 from the touch panel controller 81, the conversion part 99 of the sensor controller 91 rewrites “φ” of the data group (X, Y, φ) to a pressure value Pₙ, the rewritten data group (X, Y, Pₙ) is output to the touch panel driver 103 from the sensor controller 91. The conversion part 99 of the sensor controller 91 of the present embodiment corresponds to an example of the rewriter of the present invention.

Instead of the touch panel filter driver 105, as shown in FIG. 14, the touch panel controller 81 may include the conversion part 82.

In this case, a pressure value Pₙ is output to the touch panel controller 81 from the sensor controller 91, the conversion part 82 of the touch panel controller 81 rewrites “φ” of the data group (X, Y, φ) to a pressure value Pₙ, the rewritten data group (X, Y, Pₙ) is output to the touch panel driver 103 from the touch panel controller 81. The conversion part 82 of the touch panel controller 81 in the present embodiment corresponds to an example of the rewriter of the present invention.

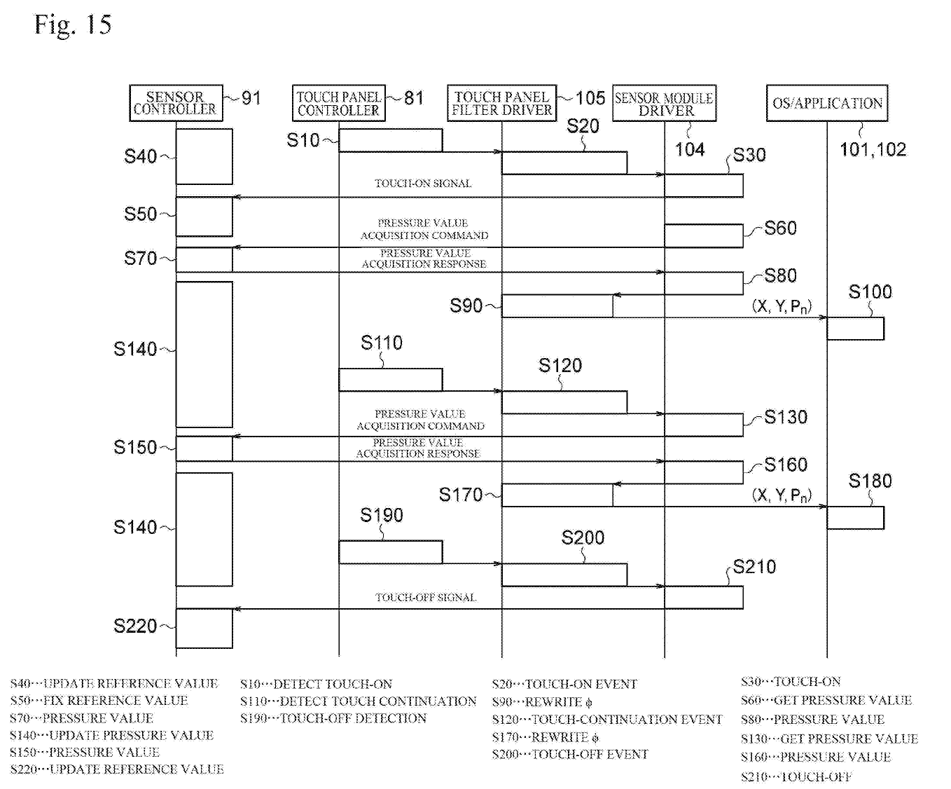

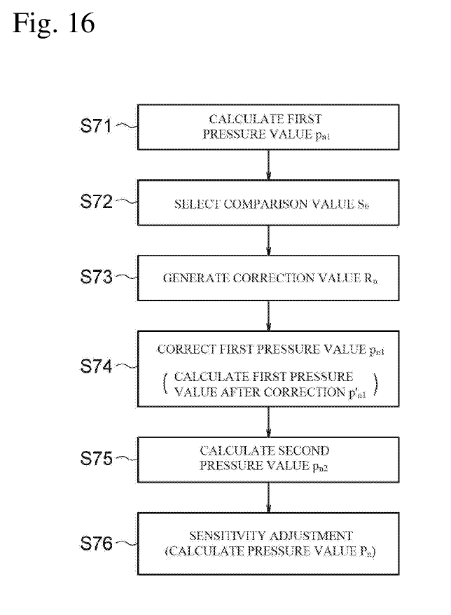

In the following, control contents of the electronic apparatus in the present embodiment is described with reference to FIG. 15 and FIG. 16. FIG. 15 is a sequence diagram showing control contents of the electronic apparatus in the present embodiment, and FIG. 16 is a flow chart showing details of the process in step S70 in FIG. 15.

In the present embodiment, when a finger of an operator contacts a cover member 20 while the operating system 101 of the computer 100 is in operation, the touch panel controller 81 notices a touch-on detection to the touch panel filter driver 105 through the touch panel driver 103 (step S10 in FIG. 15).

Next, the touch panel filter driver 105 notices a touch-on event to the sensor module driver 104 (step S20 in FIG. 15), and then the sensor module driver 104 sends a touch-on signal to the sensor controller 91 (step S30 in FIG. 15).

On the other hand, the acquisition part 92 of the sensor controller 91 periodically obtains an output value OPₙ of each of four pressure-sensitive sensors 50 in a state where the operating system 101 of the computer 100 is in operation, and periodically outputs the output value OPₙ to the setting part 93 and the first calculation part 94. Further, the setting part 93 periodically updates the reference value OPₙ until the touch-on signal is received from the sensor module driver 104 (step S40 in FIG. 15).

Then, when the sensor controller 91 receives the touch-on signal from the sensor module driver 104, the setting part 93 sets, as the reference value OP₀, the output value OPₙ sampled immediately before the detection of the contacting (step S50 in FIG. 15). The reference value OP₀ is set for each pressure-sensitive sensor 50, that is, four reference values OP₀ are set in the present embodiment.

The sensor module driver 104 sends a pressure value acquisition command to the sensor controller 91 after sending the touch-on signal (step S60 in FIG. 15). The sensor controller 91 calculates a pressure value Pₙ as follows after receiving he pressure value acquisition command (step S70 in FIG. 15).

In other words, the first calculation part 94 first calculates a first pressure value pₙ₁ from the output value OPₙ and the reference value OP₀ in accordance with the expression (5) above (step S71 in FIG. 16). The first pressure value pₙ₁ is also calculated for each pressure-sensitive sensor 50.

Next, the selection part 95 sets, as a comparison value S₀, the smallest value among the four reference values OP₀ (step S72 in FIG. 16).

Then, the correction part 96 calculates a correction value Rₙ of each pressure-sensitive sensor 50 in accordance with the expression (6) above (step S73 in FIG. 16). Next, in accordance with the expression (7) above, the first pressure value pₙ₁ is corrected using the correction value Rₙ (step S74 in FIG. 16). The correction value Rₙ is also calculated for each pressure-sensitive sensor 50.

Following this, the second calculation part 97 calculates the sum of the first pressure values after correction p′ₙ₁ of the four pressure-sensitive sensors 50 in accordance with the expression (8) above to determine a second pressure value pₙ₂ (step S75 in FIG. 16).

Then, the sensitivity adjustment part 98 calculates a final pressure value Pₙ by performing sensitivity adjustment of the second pressure value pₙ₂ in accordance with the expression (9) above (step S76 in FIG. 16).

The pressure value Pₙ calculated as above is output to the touch panel filter driver 105 through the sensor module driver 104 (step S80 in FIG. 15).

Although not particularly illustrated in drawings, the data group (X, Y, φ) is output to the touch panel filter driver 105 from the touch panel controller 81 through the touch panel driver 103. Then when the pressure value Pₙ is input to the touch panel filter driver 105 from the sensor module driver 104 in step S80 in FIG. 15, the touch panel filter driver 105 rewrites “φ” of the data group (X, Y, φ) to the pressure value Pₙ (step S90 in FIG. 15) and outputs the rewritten data group (X, Y, Pₙ) to the operating system 101 (step S100 in FIG. 15).

The touch panel controller 81 periodically obtains an X-coordinate value and a Y-coordinate value of the touched position from the touch panel 30 while contact of the finger with the cover member 20 continues, and for each time, sends a touch-continuation signal together with the data group (X, Y, φ) to the touch panel filter driver 105 through the touch panel driver 103 (step S110 in FIG. 15). Then, the touch panel filter driver 105 notices a touch-continuation event to the sensor module driver 104 (step 5120 in FIG. 15) and the sensor module driver 104 sends a pressure value acquisition signal to the sensor controller 91 (step S130 in FIG. 15).

On the other hand, the sensor controller 91 periodically calculates and updates the pressure value Pₙ in the manner described in the steps S71 to S76 above while contact of the finger to the cover member 20 continues (step S140 in FIG. 15). Subsequently, when the pressure value acquisition signal is received from the sensor module driver 104, the sensor controller 91 outputs the pressure value Pₙ to the touch panel filter driver 105 through the sensor module driver 104 (steps S150 to S160 in FIG. 15). That is, in the present embodiment, together with the periodical acquisition of the X and Y coordinate values by the touch panel controller 81, the sensor controller 91 periodically outputs the pressure value Pₙ to the computer 100.

Then, as in the steps S90 to S100 above, the touch panel filter driver 105 rewrites “φ” of the data group (X, Y, φ) output from the touch panel driver 103 to a pressure value Pₙ (step S170 in FIG. 15) and outputs the rewritten data group (X, Y, Pₙ) to the operating system 101 (step S180 in FIG. 15).

On the other hand, when a finger of an operator becomes untouched from the cover member 20, the touch panel controller 81 sends a touch-off detection signal to the touch panel filter driver 105 through the touch panel driver 103 (step S190 in FIG. 15).

Then, the touch panel filter driver 105 notices a touch-off event to the sensor module driver 104 (step S200 in FIG. 15), and the sensor module driver 104 sends a touch-off signal to the sensor controller 91 (step 5210 in FIG. 15).

Subsequently, when the sensor controller 91 receives the touch-off signal from the sensor module driver 104, the sensor controller 91 releases the settings of the reference value OP₀ and the comparison value S₀, and also, the setting part 93 periodically updates the reference value OP₀ until the touch-on signal is received from the sensor module driver 104 (step S220 in FIG. 15).

As above, in the present embodiment, a part (“φ”) of the data group (X, Y, φ) generated by the touch panel controller 81 is rewritten to a pressure value Pₙ, thus the touch panel driver 103 of the computer 100 can be used as it is. As a result, it is possible to reduce development man-hours and shorten a development period d, thus it is possible to reduce the costs of the electronic apparatus 1.

In the present embodiment, since the acquisition part 92 of the sensor controller 91 includes an A/D converter 925 and the pressure value Pₙ is digitalized before input to the computer 100, rewriting operation of the data group by the touch panel filter driver 105 can be simplified.

In the present embodiment, while the touch of the finger to the cover member 20 continues, the touch panel controller 81 periodically obtains X and Y coordinate values of the touched position. Accordingly, the sensor controller 91 also periodically outputs a pressure value Pₙ from the computer 100. Thus, the electronic apparatus 1 in the present embodiment can detect operation of the finger which does not accompany X- and Y-directional finger movement (for example, operation of strengthening or weakening of the pressure at a point).

The above-described embodiment is described for easy understanding of the invention, and is not intended to limit the invention. Accordingly, respective elements, which are disclosed in the above-described embodiment, are intended to include all design modifications or equivalents thereof which pertain to the technical scope of the invention.

For example, in the embodiment, a configuration in which the panel unit 10 includes the touch panel 30 is described. However, the configuration is not limited thereto as long as the panel unit 10 includes the cover member 20. For example, the touch panel 30 may be configured separately from the panel unit 10 such as by arranging the touch panel 30 on the display device 40 apart from the cover member 20.

The touch panel of the present invention is not particularly limited as long as it detects a coordinate value. For example, a touch sensor which detects a coordinate value is included to the touch panel of the present invention.

In the above-described embodiment, the pressure-sensitive sensors 50 are disposed at the four corners of the electronic apparatus 1, but there is no particular limitation thereto. For example, in a case where the pressure-sensitive sensor is constituted by using an electrostatic capacitance type sensor, the pressure-sensitive sensor may include a sheet-shaped electrostatic capacitive sensor and a transparent elastic member which is provided on the electrostatic capacitive sensor, and the pressure-sensitive sensor may be interposed between the touch panel 30 and the display device 40 with the transparent elastic member disposed on a touch panel 30 side. The pressure-sensitive sensor has substantially the same size as the touch panel 30, and is laid on the entirety of the rear surface of the touch panel 30. In the electrostatic capacitive sensor, a plurality of detection regions are divided, and the sensor controller 91 obtains a detection result from each of the plurality of detection regions. In this case, since the touch panel 30 and the display device 40 are fixed through the pressure-sensitive sensors, screws 44 for fixing the display device 40 to the first support member 70 are not required (refer to FIG. 2).

### DESCRIPTION OF REFERENCE NUMERALS

1: Electronic apparatus

10: Panel unit

20: Cover member

30: Touch panel

40: Display device

50, 50B: Pressure-sensitive sensor

60: Seal member

70: First support member

75: Second support member

80: Touch panel module
81: Touch panel controller
82: Conversion part

90: Sensor module
91: Sensor controller
   92: Acquisition part
      925: A/D converter
   93: Setting part
   94: First calculation part
   95: Selection part
   96: Correction part
   97: Second calculation part
   98: Sensitivity adjustment part
   99: Conversion part

100: Computer
101: Operating system (OS)
102: Application
103: Touch panel driver
104: Sensor module driver
105: Touch panel filter driver

1. An electronic apparatus comprising:
a touch panel;
a panel unit which includes at least a cover member;
at least one pressure-sensitive sensor which detects a pressing force applied through the panel unit;
a touch panel controller which generates a data group which includes at least one touch coordinate value detected by the touch panel and another value except the touch coordinate value;
a sensor controller which generates a pressure value from an output value of the pressure-sensitive sensor; and
a computer which includes at least a touch panel driver and to which the touch panel controller and the sensor controller are electrically connected, wherein
the electronic apparatus further comprises a rewriter which rewrites the other value of the data group to the pressure value.

2. The electronic apparatus according to claim 1, wherein
the computer includes an operating system to which the data group after rewriting of the other value to the pressure value is input.

3. The electronic apparatus according to claim 1, wherein
the rewriter is a filter driver which the computer includes, and
the filter driver rewrites the other value of the data group after being output from the touch panel driver, to the pressure value.

4. The electronic apparatus according to claim 1, wherein
the touch panel controller or the sensor controller includes the rewriter, and
the rewriter rewrites the other value of the data group before being input to the touch panel driver, to the pressure value.

5. The electronic apparatus according to claim 1, wherein the sensor controller periodically outputs the pressure value to the computer.

6. The electronic apparatus according to claim 1, wherein the touch panel controller sends a signal to the sensor controller, and
the sensor controller outputs the pressure value to the computer on the basis of the signal from the touch panel controller.

7. The electronic apparatus according to claim 1, wherein
the touch panel controller sends a signal to the sensor controller along with generation of the data group, and
the sensor controller periodically generates and updates the pressure value and outputs the pressure value to the computer when the signal is received from the touch panel controller.

8. A method for controlling an electronic apparatus including a touch panel, a panel unit which includes at least a cover member, at least one pressure-sensitive sensor which detects a pressure force applied through the panel unit, and a computer which includes at least a touch panel driver and to which the touch panel and the pressure-sensitive sensor are electrically connected, the method comprising:
(a) generating a data group which includes at least one touch coordinate value detected by the touch panel and another value except the touch coordinate value;
(b) generating a pressure value from an output value of the pressure-sensitive sensor; and
(c) rewriting the other value of the data group to the pressure value.

9. The method for controlling the electronic apparatus according to claim 8, wherein
the method for controlling the electronic apparatus comprises inputting the data group after rewriting of the other value to a pressure value, to an operating system which the computer includes.

10. The method for controlling the electronic apparatus according to claim 8, wherein the (c) is performed after the data group is input to the computer.

11. The method for controlling the electronic apparatus according to claim 8, wherein the (c) is performed before the data group is input to the computer.

12. The method for controlling the electronic apparatus according to claim 8, wherein the (b) includes periodically outputting the pressure value to the computer.

13. The method for controlling the electronic apparatus according to claim 8, wherein
the electronic apparatus includes:
a touch panel controller which generates the data group; and
a sensor controller which generates the pressure value,
the touch panel is electrically connected to the computer through the touch panel controller,
the pressure-sensitive sensor is electrically connected to the computer through the sensor controller,
the (a) includes outputting a signal to the sensor controller by the touch panel controller, and
the (b) includes outputting the pressure value to the computer by the sensor controller on the basis of the signal from the touch panel controller.

14. The method for controlling the electronic apparatus according to any one of claim 8, wherein
the electronic apparatus comprises:
a touch panel controller which generates the data group; and
a sensor controller which generates the pressure value,
the touch panel is electrically connected to the computer through the touch panel controller,
the pressure-sensitive sensor is electrically connected to the computer through the sensor controller,
the (a) includes outputting a signal to the sensor controller by the touch panel controller along with generation of the data group, and
the (b) includes periodically generating and updating the pressure value by the sensor controller, and outputting the pressure value to the computer by the sensor controller when the signal is received from the touch panel controller.
